(19) United States
(12) Patent Application Publication
(10) Pub. No.: US 2021/0019651 A1
(43) Pub. Date: Jan. 21, 2021

(54) METHOD FOR INTEGRATING PREDICTION RESULT

(71) Applicant: Hitachi, Ltd., Tokyo (JP)

(72) Inventors: Ken SUGIMOTO, Sunnyvale, CA (US); Michiko YOSHIDA, San Jose, CA (US)

(73) Assignee: Hitachi, Ltd.

(21) Appl. No.: 16/515,521

(22) Filed: Jul. 18, 2019

(51) Int. Cl. G06N 20/00; G06N 5/04

(52) U.S. Cl. CPC G06N 20/00; G06N 5/048

(57) ABSTRACT

Example implementations described herein involve integrating human observations into results of a machine learning process to generate an integrated failure prediction and updated machine learning models from human observations. Example implementations can involve systems and methods that, for receipt of a user input indicative of a failure symptom at a facility, conducting cause estimation on the failure symptom to determine a first set of probabilities associated with a first set of causes of the failure symptom; and integrating the first set of probabilities and first set of causes into a process configured to provide a second set of probabilities and a second set of causes of the failure symptom based on a set of potential failures associated with a third set of probabilities provided from a machine learning process configured to output the set of potential failures and the third set of probabilities based on sensor data from the facility.

### BACKGROUND

### Field

The present disclosure is generally related to fault prediction, and more specifically, to systems and methods that conduct fault prediction from an integration of machine learning systems and human controlled systems.

### Related Art

As machine learning implementations improve, fault prediction models can be developed more easily. To use such implementations, companies who own factories can develop the model to predict failures from sensor data, images, videos, and/or repair history. Failures can include the equipment fault occurring in the factories or phenomena indicative of impending failure for the factories, for example, which factory equipment will be broken next or decreasing yield rate. Such models can instruct the managers of factories to know of failures. The managers can take measurements or conduct preventative maintenance based on the predicted failures, and can thereby maintain the production line of the factory to continuously operate and reduce the possibility of missing the delivery rate.

In a related art implementation, there is an electronic system and method for estimating and predicting a failure of that electronic system, which involves implementations method for estimating and predicting a failure of the electronic system from measurements such as temperature, bulk capacitor series resistance, and so on. Such related art implementations include measuring parameters affecting the reliability of the device by sensors, collecting the measured sensor data, and communicating the data to a computing device for processing and predicting a failure and alerting to the failure.

### SUMMARY

However, if there are certain types of failures that have not occurred in the past or occur very rarely (e.g., once a year), machine learning models may be unable to predict such failures. Machine learning models require thousands of failure data points to train the failure prediction model. Further, some data relevant to the failure are not always collected because the users may not know the relevance. Under these circumstances, in some case, it can be difficult for users to find the cause of failure even after something had happened. For example, if the yield rate decreases in a semiconductor factory in a manner that has not occurred before, and the root cause is the vibration of the ground by made by a train, it can be hard to determine the cause if the user had no idea that the yield rate is relevant to the vibration of the ground. In this case, it can take a long time to determine the cause and take counter measures.

In example implementations, even if the failure prediction model cannot predict the failure, a human user may notice specific phenomena when the failure occurred. Thus, if the same type of failure had happened in another similar factory, the machine learning system should be able to determine the possible cause from the other factory data, which would not be necessarily be used for the prediction model for the factory. It is therefore possible that the machine learning models can derive some possibility of the cause based on other factory data. Further, we can know the circumstance of the factory from the fault prediction model, so, if the possible cause and failure prediction can be integrated, the example implementations can find the cause of the phenomena more easily.

Example implementations described herein are directed to systems and methods to integrate the possible cause from the failure in other factory and failure prediction for the factory when users notice some phenomena. Users can see the integrated possibilities of the cause and find the cause of their notice.

Aspects of the present disclosure can involve a method, which can include, for receipt of a user input indicative of a failure symptom at a facility, conducting cause estimation on the failure symptom to determine a first set of probabilities associated with a first set of causes of the failure symptom; and integrating the first set of probabilities and first set of causes into a process configured to provide a second set of probabilities and a second set of causes of the failure symptom based on a set of potential failures associated with a third set of probabilities provided from a machine learning process configured to output the set of potential failures and the third set of probabilities based on sensor data from the facility.

Aspects of the present disclosure can involve a system, which can include, for receipt of a user input indicative of a failure symptom at a facility, means for conducting cause estimation on the failure symptom to determine a first set of probabilities associated with a first set of causes of the failure symptom; and means for integrating the first set of probabilities and first set of causes into a process configured to provide a second set of probabilities and a second set of causes of the failure symptom based on a set of potential failures associated with a third set of probabilities provided from a machine learning process configured to output the set of potential failures and the third set of probabilities based on sensor data from the facility.

Through the example implementations described herein, users can reduce the time required to determine the cause of failures that have never or rarely happened in the factory before. The example implementations can thereby maintain the production line of the factory, and increase the production rate of the factory or reduce the possibility of missing the delivery rate.

### BRIEF DESCRIPTION OF DRAWINGS

FIG. 1 illustrates an example overall flow in accordance with an example implementation.

FIG. 2 illustrates an overall system structure on which example implementations can be applied.

FIG. 3 illustrates an example of the cause estimation, in accordance with an example implementation.

FIG. 4 illustrates an example of failure prediction, in accordance with an example implementation.

FIG. 5 illustrates an example of the integrated cause prediction, in accordance with an example implementation.

FIG. 6 illustrates an example flow to estimate cause from history, in accordance with an example implementation.

FIG. 7 illustrates the flow of creating the symptom extraction ML model, in accordance with an example implementation.

FIG. 8 illustrates an example of the failure KB in accordance with an example implementation.

FIG. 9 illustrates how to calculate the weight of each cause and normalize, in accordance with an example implementation.

FIG. 10(a) illustrates an example of factory data, in accordance with an example implementation.

FIG. 10(b) illustrates an example of the flow processing of FIGS. 6 to 9(a) in accordance with an example implementation.

FIG. 11 illustrates an example of creating a failure prediction ML model in accordance with an example implementation.

FIG. 12 illustrates an example to integrate the cause estimation and failure prediction, in accordance with an example implementation.

FIG. 13(a) illustrates an example flow to integrate cause estimation from failure prediction and human observation, in accordance with an example implementation.

FIG. 13(b) illustrates an example processing of FIG. 12 and FIG. 13(a), in accordance with an example implementation.

FIG. 14 illustrates an example flow of feedback to the machine learning model, in accordance with an example implementation.

FIG. 15 illustrates a system involving a plurality of industrial environments and a management apparatus, in accordance with an example implementation.

FIG. 16 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein are directed to investigating the cause of the failure for events that have never happened before, or have rarely happened to the extent that insufficient data has been accumulated for the failure prediction model. Example implementations described herein are directed to industrial environments, such as factories. Through utilizing human observations as well as the sensor data, the detection of failure can be significantly enhanced compared to related art implementations only conducting failure prediction from sensor data, and the machine learning process can be trained to provide more accurate results to provide more accurate failure predictions even if such failure events are sparse in nature.

Further, the system as described in example implementations herein can be extended to multiple facilities/factories, so that the system uses human observations and sensor data from multiple facilities/factories. Thus, if an event occurs in one facility that has never occurred before, the history of other facilities that experienced the same problem can be utilized to determine the potential causes of the failure and the associated probabilities.

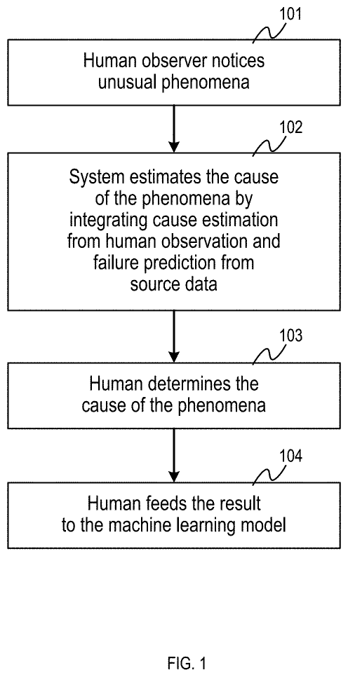

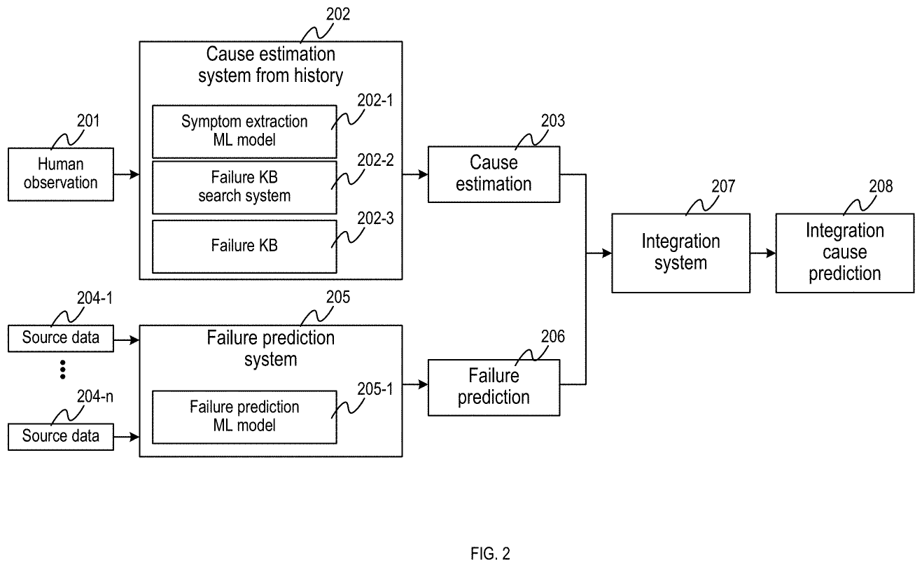

FIG. 1 illustrates an example overall flow in accordance with an example implementation. In a factory or other industrial setting, a human observer may observe unusual phenomena at 101. For example, yield rate decrease at some timing or some products have resulted in less glitter. At 102, the system estimates the cause of the phenomena, which is further described in FIG. 2. At 103, the human observer is provided with the estimation of the cause from the system and provides an input result as to the cause of the phenomena. At 104, the human observer can then provide the input result to the machine learning (ML) model if needed, which can include additional annotations such as a recommendation to increase the number of sensors, or obtain new equipment to collect data.

FIG. 2 illustrates an overall system structure on which example implementations can be applied. In example implementations, there can be two types of input. One type of input is human observation 201. If a human observer notices strange phenomena, the human observer can submit that observation to the system through any user interface in accordance with the desired implementation. Cause estimation system from history 202 can obtain the human observation and create a cause estimation 203 using a failure knowledge base (KB) 202-3 which is composed of a history regarding the failure events from other factories, as well as symptom extraction ML model 202-1 and failure KB search system 202-2. The other type of input can include source data 204-1-204-n, which includes sensor data of equipment, video or image data, repair history and so on in accordance with the desired implementation. Failure prediction system 205 creates the failure prediction 206 using failure prediction ML model 205-1. Integration system 207 integrates the cause estimation 203 and the failure prediction 206 to create integrated cause prediction 208. The human observer is then given the integrated cause prediction and failure prediction, which allows the human observer to determine the cause of the phenomena.

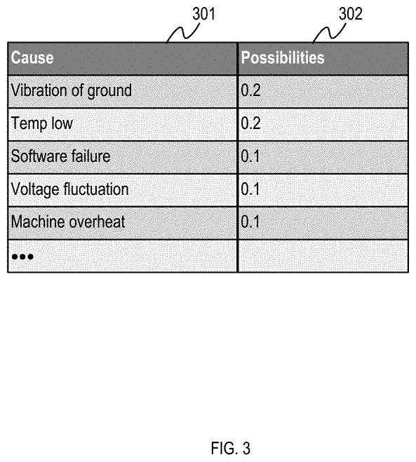

FIG. 3 illustrates an example of the cause estimation 203, in accordance with an example implementation. This table includes cause 301 and possibilities 302. Causes 301 are for example, vibration of ground, temp low, software failure and so on in accordance with the desired implementation. Possibilities 302 can indicate a weight, probability, or other score associated with the cause 301 in accordance with the desired implementation.

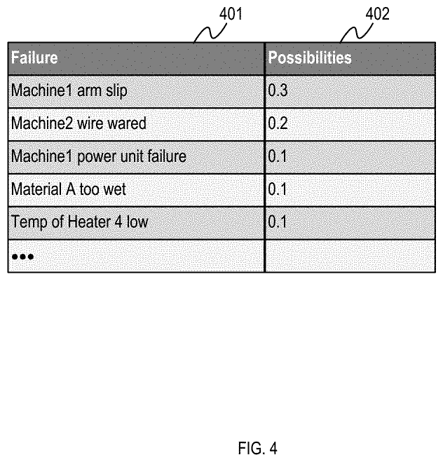

FIG. 4 illustrates an example of failure prediction 204, in accordance with an example implementation. This table includes failure 401 and possibilities 402. Failures can include, for example, machine 1 arm slip, machine 2 wire wared, and so on in accordance with the desired implementation. Possibilities 302 can indicate a weight, probability, or other score associated with the failure 401 in accordance with the desired implementation.

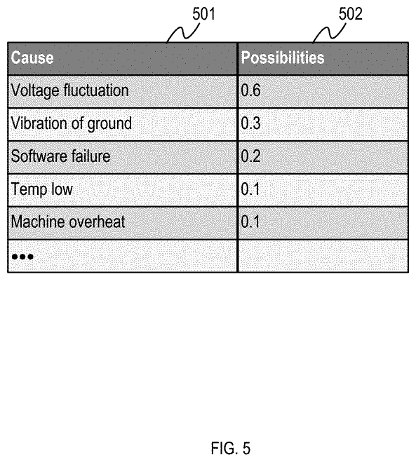

FIG. 5 illustrates an example of the integrated cause prediction 208, in accordance with an example implementation. This table includes cause 501 and possibilities 502. Causes can be the same as cause 301 in FIG. 3, which can include, for example, vibration of ground, temp low, software failure and so on in accordance with the desired implementation. Possibilities 302 can indicate a weight, probability, or other score associated with the cause 501 in accordance with the desired implementation.

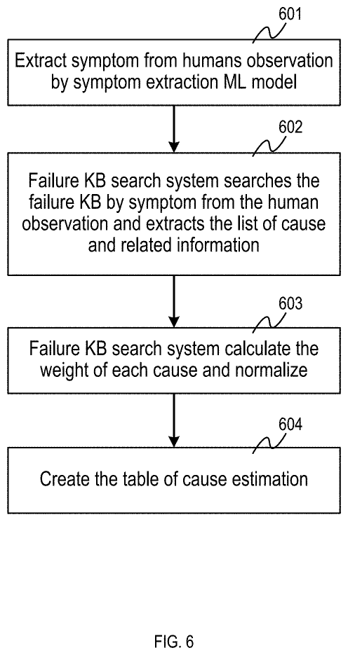

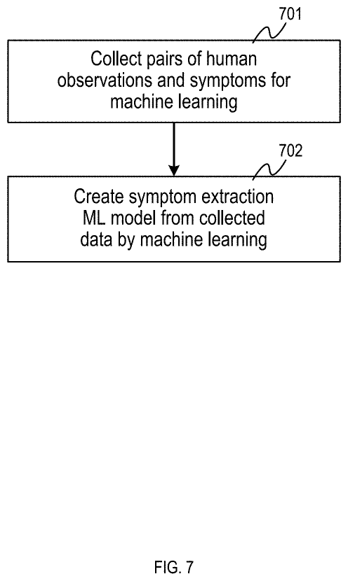

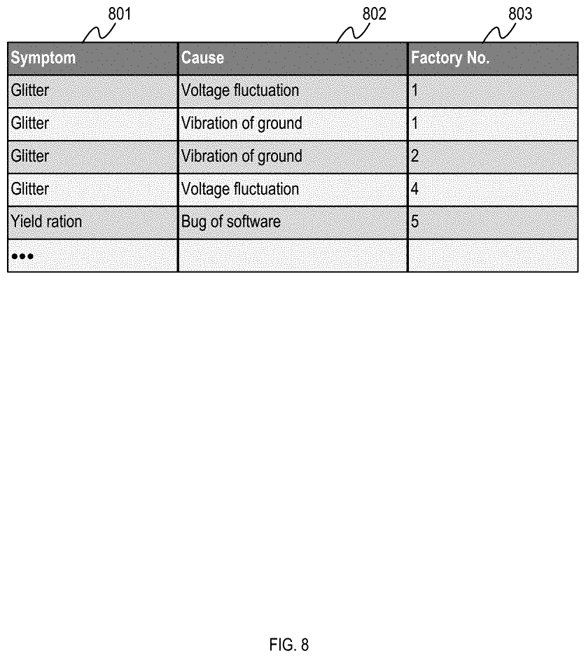

FIG. 6 illustrates an example flow to estimate cause from history as shown at 202, in accordance with an example implementation. At 601, the flow extracts the symptom from humans observation by utilizing symptom extraction ML model 202-1. Symptom extraction ML model 202-1 extracts the symptom from human observation. An example implementation to create symptom extraction ML model 202-1 is provided in FIG. 7. At 602, the failure KB search system 202-2 searches the failure KB 202-3 by symptom from the human observation, and extracts the list of causes and factory numbers. The way to extract the list from failure KB 202-3 is through utilizing the Question and Answer (Q&A) system. One example is to execute an exact match between the failure KB symptom column and the symptom extracted from the human notice. An example implementation of the structure of failure KB 202-3 is shown in more detail at FIG. 8.

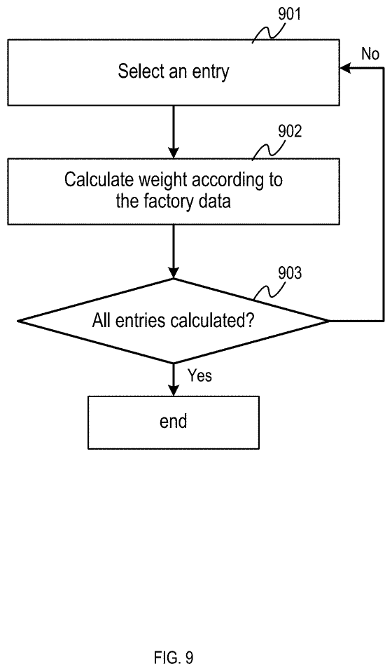

At 603, the failure KB search system 202-2 calculates the weight of each cause and normalizes the values. An example implementation for the way to calculate the weight of each cause is shown in FIG. 9.

At 604, the flow creates the table of cause estimation as shown in FIG. 3.

FIG. 7 illustrates the flow of creating the symptom extraction ML model 202-1, in accordance with an example implementation. Specifically, the flow in FIG. 7 illustrates how to create machine learning model. Users can use any type of machine learning model (e.g., Long short-term memory (LSTM)).

At 701, the flow collects pairs of human observations and symptoms for machine learning. At 702, the flow creates the symptom extraction ML model from collected data by machine learning.

FIG. 8 illustrates an example of the failure KB 202-3 in accordance with an example implementation. Failure KB can include symptom 801, cause 802, and product column 803. Failure KB can be created from failure reports of other factories. These reports may be in a text format. Text can be changed by human resources or by a system to transform from text to structured data, depending on the desired implementation.

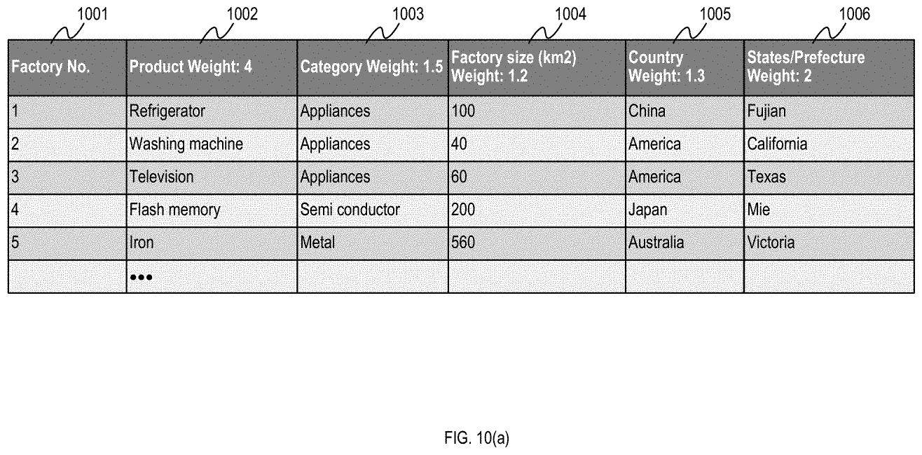

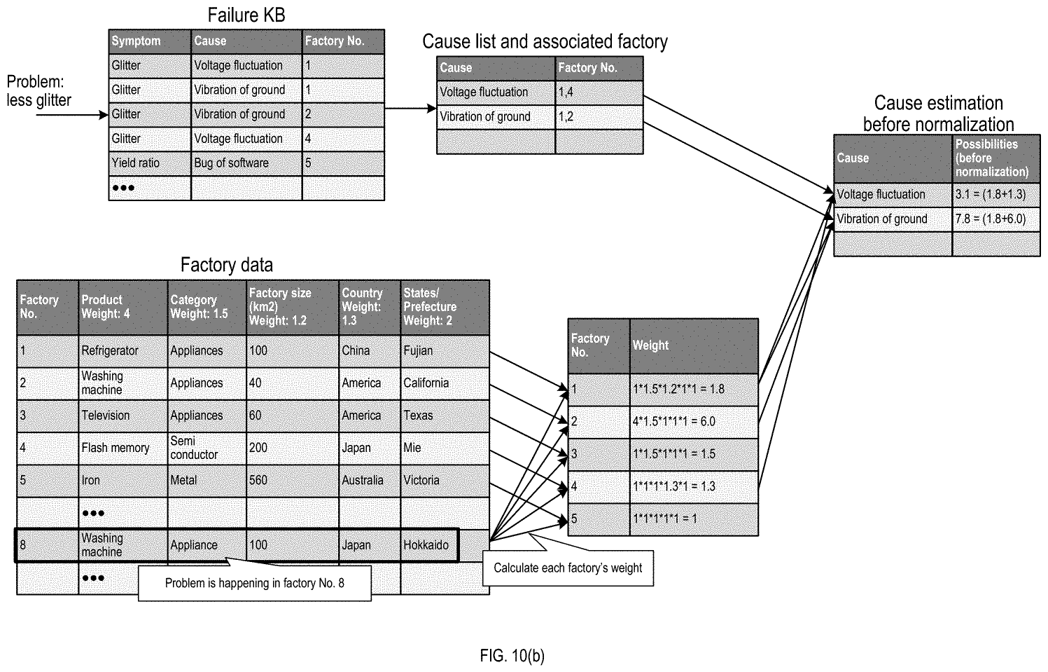

FIG. 9 illustrates how to calculate the weight of each cause and normalize, in accordance with an example implementation. This figure provides detail for the failure KB search system as shown at 603 of FIG. 6. At 901, the flow selects an entry from product factory data as shown in FIG. 10(a), and calculates the weight for the factory data at 902. At 903, a determination is made as to whether all entries are processed. If so (Yes) then the flow ends, otherwise (No) the flow proceeds to 901 to select the next entry.

In an example implementation to calculate weights, a determination is made as to whether the columns match the column of the factory in which the problem is occurring. Each column has a weight, and the example implementations calculate the weight for each factory by multiplying the weight. If the column does not match, the weight is assumed as 1. For example, supposed the factory data involving the problem is Factory No. 8, Product: washing machine, Category: appliance, Size: 100 km2, Location: Japan, States/Prefecture: Hokkaido. The column of category whose weight is 1.5 and size matches whose weight is 1.2 with factory No. 1. So, weight of Factory No. 1 is calculated as 1.2*1.5=1.8.

When all entries are calculated at 903, the result is used for calculating cause estimation shown in FIG. 6.

FIG. 10(a) illustrates an example of factory data, in accordance with an example implementation. The factory data includes the Factory No. 1001 which is used as the primary key. Each column other than the Factory No. 1001 includes a weight, which is used to calculate the weight at 902. Factory data may include product 1002, category 1003, factory size 1004, country 1005, and states/prefecture 1006.

FIG. 10(b) illustrates an example of the flow processing of FIGS. 6 to 10(a) in accordance with an example implementation. In the example of FIG. 10(b), a user interface receives a user input regarding a human observation that there is less glitter in a semiconductor production line. The failure KB is traversed to search for the causes and related information (e.g., other factories/facilities that encountered the same cause) as described at 602 of FIG. 6. The factory data is traversed to determine the corresponding weight to be assigned to the other factories/facilities. In the example of FIG. 10(b), the human observation is input from factory No. 8, whereupon relative to factory No. 8, the weights are calculated from factory data described in FIG. 10(a) managed by the system based on similarity. For example, the product, category, factory size, country, and state/prefecture of factory are parameters taken into consideration to generate a composite weight for each factory. The weights associated with each parameter can be adjusted according to the desired implementation and is not limited to the example of FIG. 10(b). In the example illustrated in FIG. 10(b), weights are assigned as multipliers, in that matching parameters are given the weight score assigned for the parameter, and non-matching parameters are given a weight of 1. The causes are then associated with a weight based on the associated factory weights, and the probabilities are determined from a normalization process accordingly.

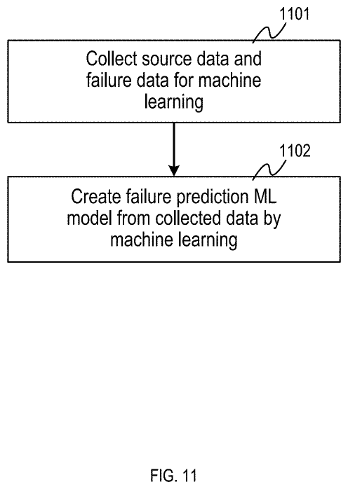

FIG. 11 illustrates an example of creating a failure prediction ML model in accordance with an example implementation. The flow is an example to create a failure prediction ML model as shown at 205-1 of FIG. 2 from source data 204-1 to 204-n, which is used to generate a failure prediction 206. At 1101, the flow collects source data and failure data for machine learning. At 1102, the flow creates a failure prediction ML model from the collected data by using a machine learning process.

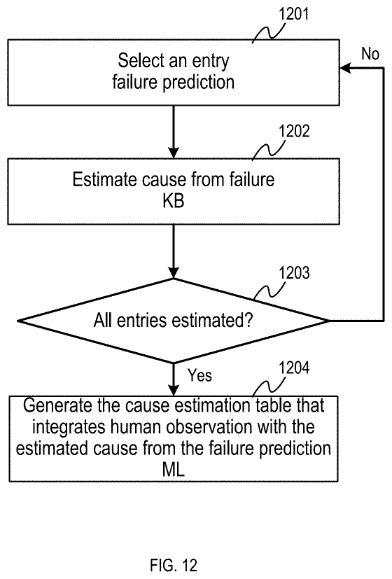

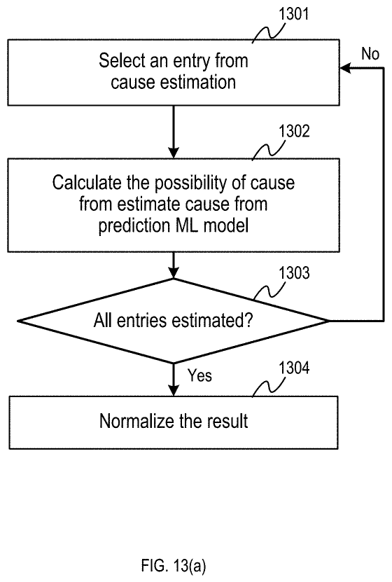

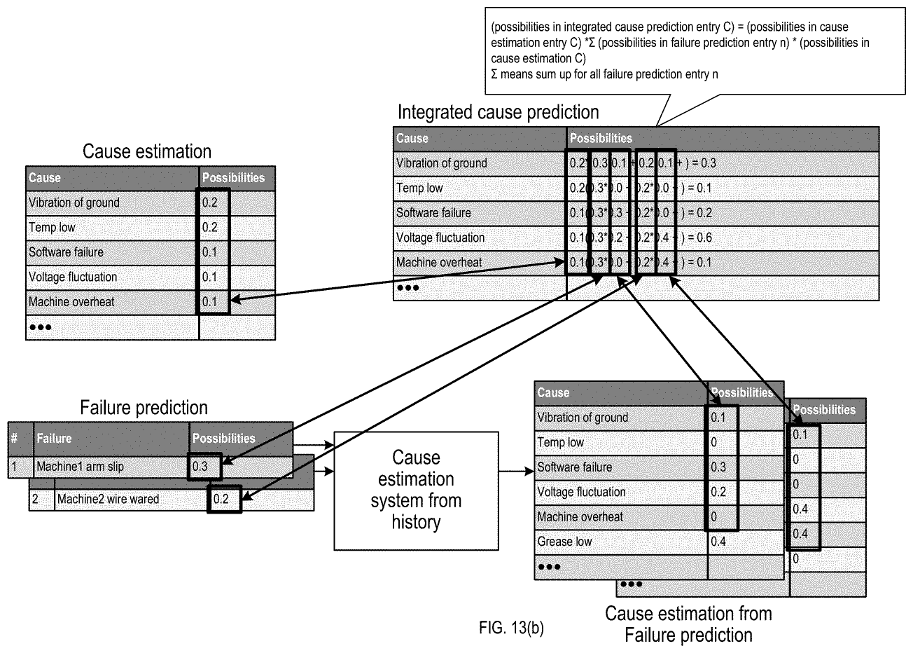

FIG. 12 illustrates an example flow to integrate the cause estimation and failure prediction 207, in accordance with an example implementation. At 1201, an entry is selected for failure prediction. At 1202, the cause is estimated from the failure KB. For example, entry “machine 1 arm slip” can be selected in accordance with the desired implementation, wherein cause estimation is determined by applying the cause estimation model from history 202 to the entry “machine 1 arm slip”. At 1203, the process loops to 1201 until all entries are estimated. At 1203, if all entries are estimated (Yes), then the flow proceeds to 1204 so that there is a cause estimation for each failure prediction entry. At 1204, the flow generates the cause estimation table that integrates human observation with the estimated cause from the failure prediction ML, which is described in FIG. 13(a), and as illustrated in FIG. 13(b).

FIG. 13(a) illustrates an example flow to integrate cause estimation from failure prediction and human observation, in accordance with an example implementation. The flow of FIG. 13 is a detailed flow for 1204 of FIG. 12. At 1301, the flow selects an entry from cause estimation, in accordance with the desired implementation to facilitate the selection. At 1302, the weight of each entry is calculated from using cause estimation from failure prediction. An example implementation to conduct the calculation can include (possibilities in integrated cause prediction entry C)=(possibilities in cause estimation entry C)*Σ(possibilities in failure prediction entry n)*(possibilities in cause estimation C). At 1303, the flow calculates each entry of cause estimation from human observation and the process loops until all entries are estimated. At 1304, the result is normalized by the sum of possibilities to 1 (e.g., total probability=1) to obtain the final cause estimation. An example of the processing is illustrated in FIG. 13(b) using the “machine 1 arm slip” example of FIG. 12.

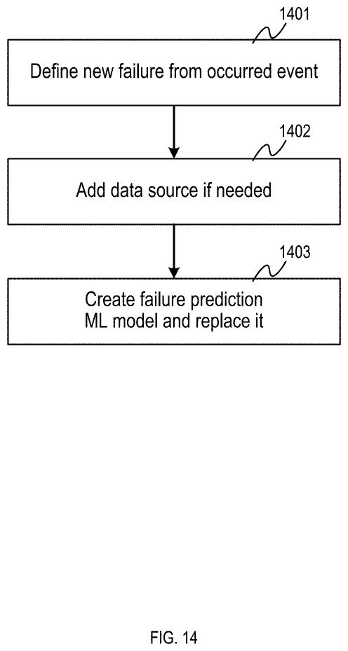

FIG. 14 illustrates an example flow of feedback to the machine learning model, in accordance with an example implementation.

First, a new failure is defined based on the occurred event at 1401. For example, if the event revealed a decrease in glitter due to ground vibration, then decreasing glitter is defined as a new failure. At 1402, data sources are added in accordance with the desired implementation. For example, if camera data is needed to detect glitter, then instructions are sent to the corresponding location set up a new camera and collect camera data. At 1403, the flow creates another failure prediction ML model 205-1 and replaces the previously stored failure prediction ML through the same flow as FIG. 7.

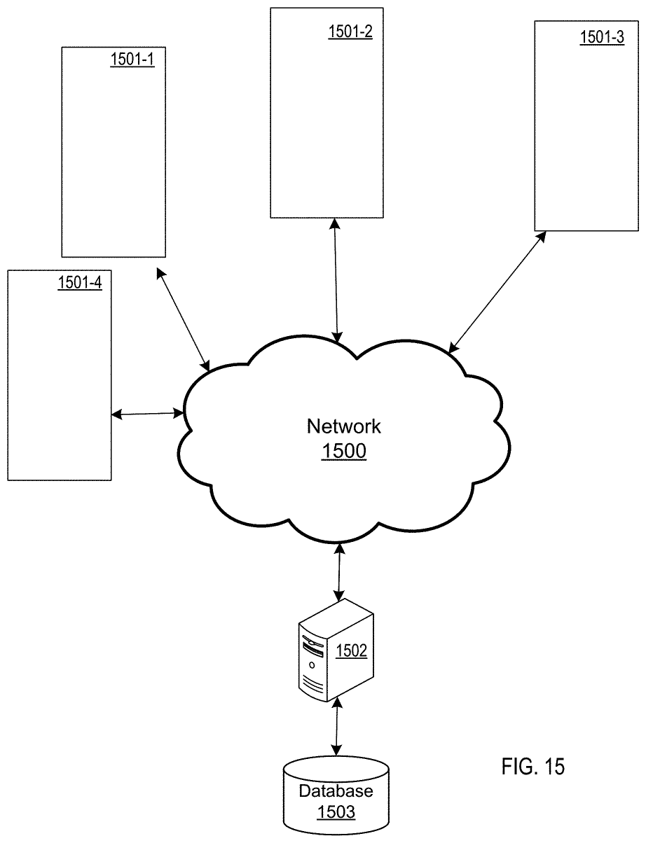

FIG. 15 illustrates a system involving a plurality of industrial environments and a management apparatus, in accordance with an example implementation. One or more industrial environments 1501-1, 1501-2, 1501-3, and 1501-4 such as factories or other such industrial facilities are communicatively coupled to a network 1500 and provide sensor data to a management apparatus 1502 configured to receive such data and utilize the data to generate a response from a machine learning process. The management apparatus 1502 manages a database 1503, which manages management information such as that illustrated in FIGS. 2 to 5 and FIG. 8.

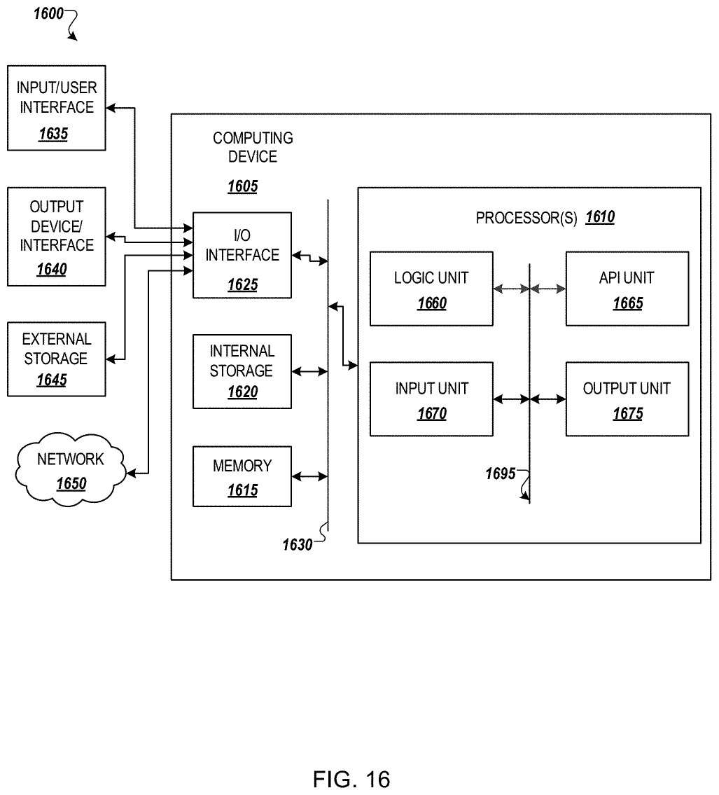

FIG. 16 illustrates an example computing environment with an example computer device suitable for use in some example implementations, such as a management apparatus 1502 as illustrated in FIG. 15. Computer device 1605 in computing environment 1600 can include one or more processing units, cores, or processors 1610, memory 1615 (e.g., RAM, ROM, and/or the like), internal storage 1620 (e.g., magnetic, optical, solid state storage, and/or organic), and/or I/O interface 1625, any of which can be coupled on a communication mechanism or bus 1630 for communicating information or embedded in the computer device 1605. I/O interface 1625 is also configured to receive images from cameras or provide images to projectors or displays, depending on the desired implementation.

Computer device 1605 can be communicatively coupled to input/user interface 1635 and output device/interface 1640. Either one or both of input/user interface 1635 and output device/interface 1640 can be a wired or wireless interface and can be detachable. Input/user interface 1635 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1640 may include a display, television, monitor, printer, speaker, braille, or the like. In some example implementations, input/user interface 1635 and output device/interface 1640 can be embedded with or physically coupled to the computer device 1605. In other example implementations, other computer devices may function as or provide the functions of input/user interface 1635 and output device/interface 1640 for a computer device 1605.

Examples of computer device 1605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1605 can be communicatively coupled (e.g., via I/O interface 1625) to external storage 1645 and network 1650 for communicating with any number of networked components, devices, and systems, including one or more computer devices of the same or different configuration. Computer device 1605 or any connected computer device can be functioning as, providing services of, or referred to as a server, client, thin server, general machine, special-purpose machine, or another label.

I/O interface 1625 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1600. Network 1650 can be any network or combination of networks (e.g., the Internet, local area network, wide area network, a telephonic network, a cellular network, satellite network, and the like).

Computer device 1605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1610 can execute under any operating system (OS) (not shown), in a native or virtual environment. One or more applications can be deployed that include logic unit 1660, application programming interface (API) unit 1665, input unit 1670, output unit 1675, and inter-unit communication mechanism 1695 for the different units to communicate with each other, with the OS, and with other applications (not shown). The described units and elements can be varied in design, function, configuration, or implementation and are not limited to the descriptions provided. Processor(s) 1610 can be in the form of hardware processors such as central processing units (CPUs) or in a combination of hardware and software units.

In some example implementations, when information or an execution instruction is received by API unit 1665, it may be communicated to one or more other units (e.g., logic unit 1660, input unit 1670, output unit 1675). In some instances, logic unit 1660 may be configured to control the information flow among the units and direct the services provided by API unit 1665, input unit 1670, output unit 1675, in some example implementations described above. For example, the flow of one or more processes or implementations may be controlled by logic unit 1660 alone or in conjunction with API unit 1665. The input unit 1670 may be configured to obtain input for the calculations described in the example implementations, and the output unit 1675 may be configured to provide output based on the calculations described in example implementations.

Memory 1615 can be configured to extract appropriate entries from database 1503 to facilitate the example implementations by providing management information as illustrated in FIGS. 2, 3, 5 and 8. Database 1503 may be facilitated by internal storage 1620, external storage 1645, or a combination of both in accordance with the desired implementation.

In an example implementation, processor(s) 1610 is configured to facilitate a user interface directed to any user at any of the facilities 1501-1, 1501-2, 1501-3, 1501-4 which can be accessed by a mobile device from a user, a device at the facility, or otherwise in accordance with the desired implementation. The interface can be configured to receive user input indicative of a failure symptom as described with respect to the human observation described herein. For receipt of a user input indicative of a failure symptom at a facility, processor(s) 1610 is configured to conduct cause estimation on the failure symptom to determine a first set of probabilities associated with a first set of causes of the failure symptom as illustrated in FIG. 10(b) through the processes of FIGS. 6 to 9(a) and as illustrated in FIG. 2 from 201 to 203; and integrate the first set of probabilities and first set of causes into a process configured to provide a second set of probabilities and a second set of causes of the failure symptom based on a set of potential failures associated with a third set of probabilities provided from a machine learning process configured to output the set of potential failures and the third set of probabilities based on sensor data from the facility as illustrated in FIG. 13(b) through the processes of FIGS. 12 and 13(a) and as illustrated in FIG. 2 from 205-208.

Processor(s) 1610 can be further configured to train the machine learning process through providing feedback of one or more of the second set of causes of the failure symptom to the machine learning process as illustrated in FIG. 14. Training can be done, for example, through execution of the process of FIG. 7.

As described herein, processor(s) 1610 can be configured to conduct cause estimation by referring to a database (e.g., the KB database) to determine the first set of causes from the failure symptom, the database associating a plurality of failure symptoms with a plurality of causes as reported from a plurality of facilities as illustrated in the processes as illustrated in FIG. 8; determining a weight for each cause of the first set of causes based on ones of the plurality of facilities associated with the each cause of the first set of causes as illustrated in FIG. 10(b); and normalizing the weights for the first set of causes to generate the first set of probabilities through normalizing the possibilities to sum up to a total of 1, thereby indicating a probability of each cause.

Processor(s) 1610 are configured to facilitate the process configured to provide the second set of probabilities and the second set of causes of the failure symptom based on the set of potential failures associated with the third set of probabilities provided from the machine learning process configured to output the set of potential failures and the third set of probabilities based on sensor data from the facility by translating the set of potential failures and the third set of probabilities into a translated set of causes and translated set of probabilities; and calculating the second set of causes and the second set of probabilities from an integrated calculation of the first set of causes, the translated set of causes, the first set of probabilities, and the translated set of probabilities as illustrated in FIG. 13(b). The processor 1610 is configured to translate the set of potential failures and the third set of probabilities into the translated set of causes and the translated set of probabilities by utilizing a database associating a plurality of failure symptoms with a plurality of causes as reported from a plurality of facilities as illustrated in FIGS. 10-12.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of a user input indicative of a failure symptom at a facility:
conducting cause estimation on the failure symptom to determine a first set of probabilities associated with a first set of causes of the failure symptom; and
integrating the first set of probabilities and first set of causes into a process configured to provide a second set of probabilities and a second set of causes of the failure symptom based on a set of potential failures associated with a third set of probabilities provided from a machine learning process configured to output the set of potential failures and the third set of probabilities based on sensor data from the facility.

2. The method of claim 1, further comprising training the machine learning process through providing feedback of one or more of the second set of causes of the failure symptom to the machine learning process.

3. The method of claim 1, wherein the conducting cause estimation comprises:
referring to a database to determine the first set of causes from the failure symptom, the database associating a plurality of failure symptoms with a plurality of causes as reported from a plurality of facilities;
determining a weight for each cause of the first set of causes based on ones of the plurality of facilities associated with the each cause of the first set of causes; and
normalizing the weights for the first set of causes to generate the first set of probabilities.

4. The method of claim 1, wherein the process configured to provide the second set of probabilities and the second set of causes of the failure symptom based on the set of potential failures associated with the third set of probabilities provided from the machine learning process configured to output the set of potential failures and the third set of probabilities based on sensor data from the facility comprises:
translating the set of potential failures and the third set of probabilities into a translated set of causes and translated set of probabilities; and
calculating the second set of causes and the second set of probabilities from an integrated calculation of the first set of causes, the translated set of causes, the first set of probabilities, and the translated set of probabilities.

5. The method of claim 4, wherein the translating the set of potential failures and the third set of probabilities into the translated set of causes and the translated set of probabilities comprises utilizing a database associating a plurality of failure symptoms with a plurality of causes as reported from a plurality of facilities.

6. A non-transitory computer readable medium, storing instructions to execute a process, the instructions comprising:
for receipt of a user input indicative of a failure symptom at a facility:
conducting cause estimation on the failure symptom to determine a first set of probabilities associated with a first set of causes of the failure symptom; and
integrating the first set of probabilities and first set of causes into a process configured to provide a second set of probabilities and a second set of causes of the failure symptom based on a set of potential failures associated with a third set of probabilities provided from a machine learning process configured to output the set of potential failures and the third set of probabilities based on sensor data from the facility.

7. The non-transitory computer readable medium of claim 6, the instructions further comprising training the machine learning process through providing feedback of one or more of the second set of causes of the failure symptom to the machine learning process.

8. The non-transitory computer readable medium of claim 6, wherein the conducting cause estimation comprises:
referring to a database to determine the first set of causes from the failure symptom, the database associating a plurality of failure symptoms with a plurality of causes as reported from a plurality of facilities;
determining a weight for each cause of the first set of causes based on ones of the plurality of facilities associated with the each cause of the first set of causes; and
normalizing the weights for the first set of causes to generate the first set of probabilities.

9. The non-transitory computer readable medium of claim 6, wherein the process configured to provide the second set of probabilities and the second set of causes of the failure symptom based on the set of potential failures associated with the third set of probabilities provided from the machine learning process configured to output the set of potential failures and the third set of probabilities based on sensor data from the facility comprises:
translating the set of potential failures and the third set of probabilities into a translated set of causes and translated set of probabilities; and
calculating the second set of causes and the second set of probabilities from an integrated calculation of the first set of causes, the translated set of causes, the first set of probabilities, and the translated set of probabilities.

10. The non-transitory computer readable medium of claim 9, wherein the translating the set of potential failures and the third set of probabilities into the translated set of causes and the translated set of probabilities comprises utilizing a database associating a plurality of failure symptoms with a plurality of causes as reported from a plurality of facilities.

11. An apparatus, comprising:
a processor, configured to, for receipt of a user input indicative of a failure symptom at a facility:
conduct cause estimation on the failure symptom to determine a first set of probabilities associated with a first set of causes of the failure symptom; and
integrate the first set of probabilities and first set of causes into a process configured to provide a second set of probabilities and a second set of causes of the failure symptom based on a set of potential failures associated with a third set of probabilities provided from a machine learning process configured to output the set of potential failures and the third set of probabilities based on sensor data from the facility.

12. The apparatus of claim 11, the processor further configured to train the machine learning process through providing feedback of one or more of the second set of causes of the failure symptom to the machine learning process.

13. The apparatus of claim 11, the processor configured to conduct cause estimation by:
referring to a database to determine the first set of causes from the failure symptom, the database associating a plurality of failure symptoms with a plurality of causes as reported from a plurality of facilities;
determining a weight for each cause of the first set of causes based on ones of the plurality of facilities associated with the each cause of the first set of causes; and
normalizing the weights for the first set of causes to generate the first set of probabilities.

14. The apparatus of claim 11, wherein the process configured to provide the second set of probabilities and the second set of causes of the failure symptom based on the set of potential failures associated with the third set of probabilities provided from the machine learning process configured to output the set of potential failures and the third set of probabilities based on sensor data from the facility comprises:
translating the set of potential failures and the third set of probabilities into a translated set of causes and translated set of probabilities; and
calculating the second set of causes and the second set of probabilities from an integrated calculation of the first set of causes, the translated set of causes, the first set of probabilities, and the translated set of probabilities.

15. The apparatus of claim 14, wherein the processor is configured to translate the set of potential failures and the third set of probabilities into the translated set of causes and the translated set of probabilities by utilizing a database associating a plurality of failure symptoms with a plurality of causes as reported from a plurality of facilities.
